(19) United States
(12) Patent Application Publication
(10) Pub. No.: US 2025/0229399 A1
(43) Pub. Date: Jul. 17, 2025

(54) Multi-Tool Device

(71) Applicant: Nicholas Sanders- Mud, Batavia, IL (US)

(72) Inventor: Nicholas Sanders- Mud, Batavia, IL (US)

(21) Appl. No.: 18/539,972

(22) Filed: Jan. 11, 2024

(51) Int. Cl. B25F 1/00; B25C 11/00

(52) U.S. Cl. CPC B25F 1/006; B25C 11/00

(57) ABSTRACT

A multi-tool device for removing flooring, walls, and trim includes a shaft having a first end distal to a second end. A first tool head is coupled to the first end. The first tool head includes a claw extending outwardly from the first end. The claw is curved and is parallel to the shaft. A second tool head is coupled to the second end. The second tool head includes an adze blade extending outwardly from the second end. The adze blade is perpendicular to the shaft and is curved. A pick extends outwardly from the second end. The pick is perpendicular to the shaft and to the adze blade. The second end also includes a pair of faces. Each of the pair of faces has a rectangular shape and is flat wherein each of the pair of faces facilitates a user in hammering an external object.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to demolition tools and more particularly pertains to a new demolition tool for removing flooring, walls, and trim.

### (2) Description of Related Art Including Information Disclosed Under 37 CFR 1.97 and 1.98

The prior art relates to demolition tools. Demolition tools are used in renovations, construction projects, and in forceable entry for rescue attempts. For example, a wrecking bar or pry bar may be used to tear apart wooden boards or remove nails from boards. An adze may be used to cut or shape pieces of wood. A hammer may be used to break the boards, pound the boards into a particular position or to pound nails into the boards to keep them together. Currently, a user must have a separate device for the pry bar, the adze, and the hammer. The user accordingly needs to bring multiple tools to a particular job site. The user also needs to find the particular tool the user needs for a given task, which can slow down workflow. When the user is trying to perform a rescue, carrying multiple tools or taking extra time to find the right tool may be impractical or impossible. Thus, there is a need in the art for a single, multi-use demolition tool that can provide the functionality of the pry bar, the adze, and the hammer.

### BRIEF SUMMARY OF THE INVENTION

An embodiment of the disclosure meets the needs presented above by generally comprising a shaft having a first end distal to a second end. A first tool head is coupled to the first end. The first tool head includes a claw extending outwardly from the first end. The claw is curved and is parallel to the shaft. A second tool head is coupled to the second end. The second tool head includes an adze blade extending outwardly from the second end. The adze blade is perpendicular to the shaft and is curved. A pick extends outwardly from the second end. The pick is perpendicular to the shaft and to the adze blade. The second end also includes a pair of faces. Each of the pair of faces has a rectangular shape and is flat wherein each of the pair of faces is configured to facilitate a user in hammering an external object.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front isometric view of a multi-tool device according to an embodiment of the disclosure.

FIG. 2 is a front view of an embodiment of the disclosure.

FIG. 3 is a top view of an embodiment of the disclosure.

FIG. 4 is a rear view of an embodiment of the disclosure.

FIG. 5 is a bottom view of an embodiment of the disclosure.

FIG. 6 is a detail view of an embodiment of the disclosure.

FIG. 7 is a detail view of an embodiment of the disclosure.

FIG. 8 is an in-use view of an embodiment of the disclosure.

FIG. 9 is an in-use view of an embodiment of the disclosure.

### DETAILED DESCRIPTION OF THE INVENTION

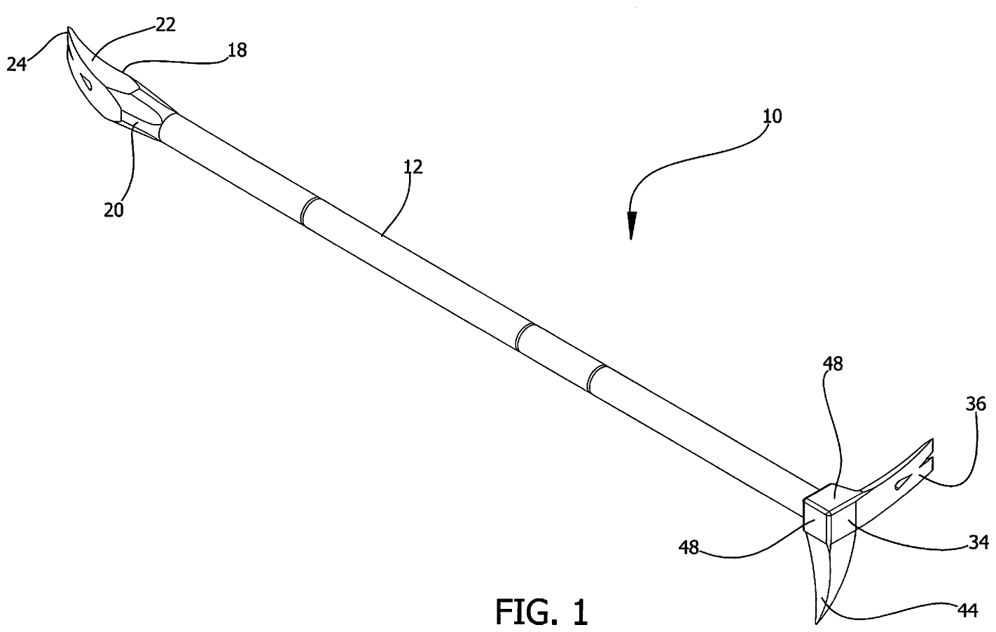

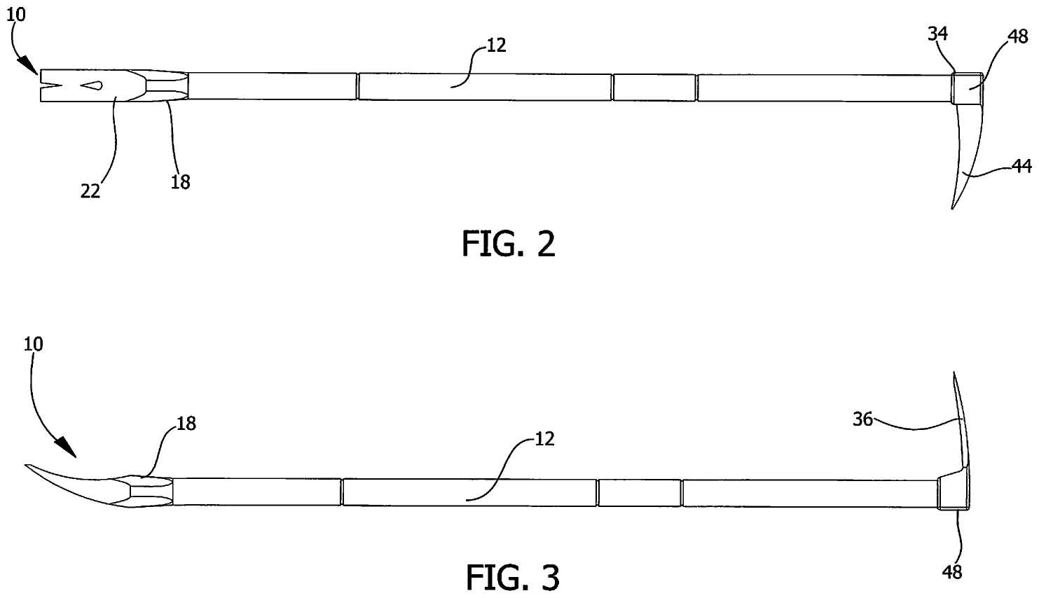

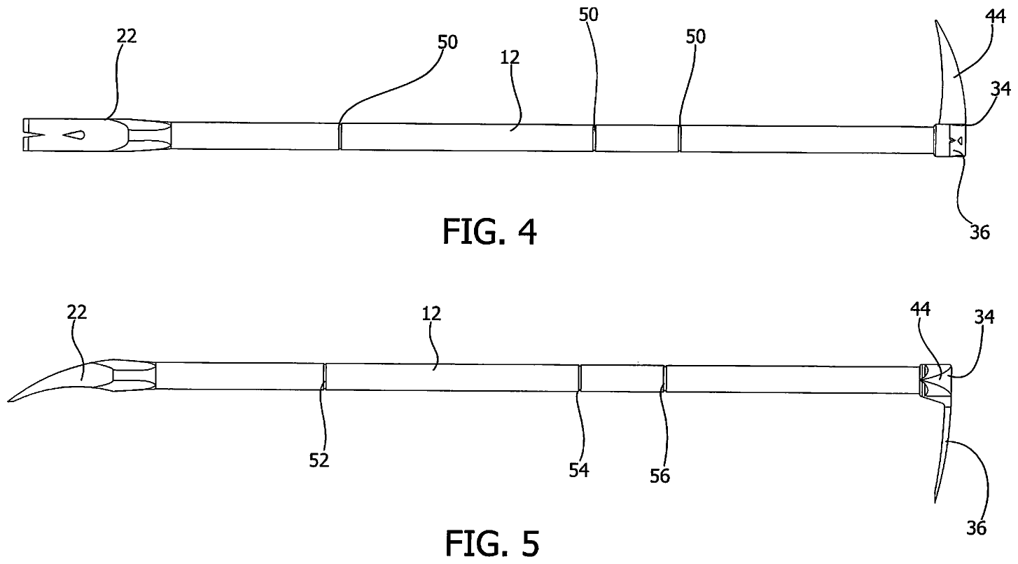

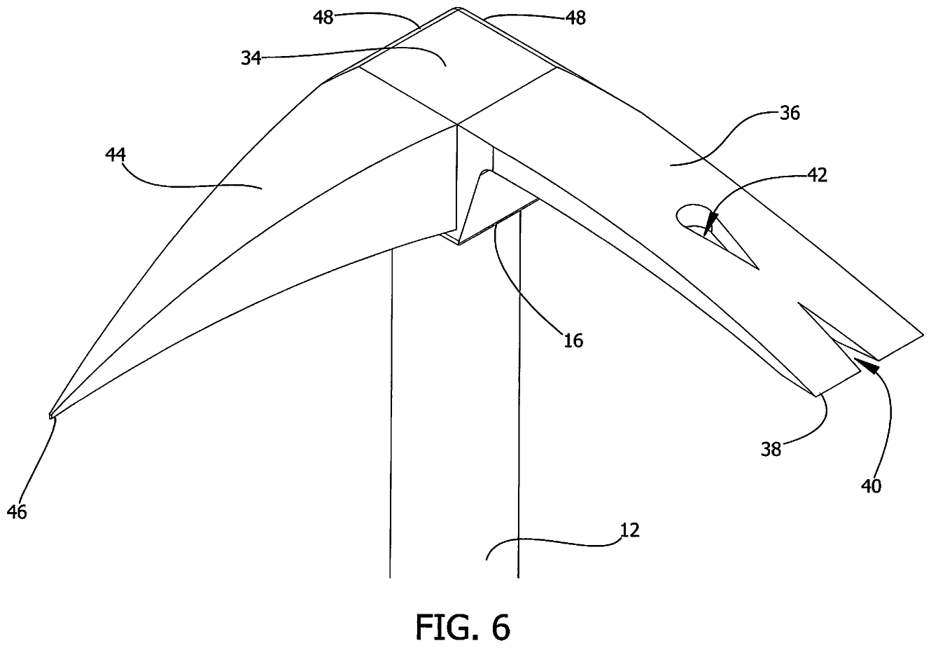

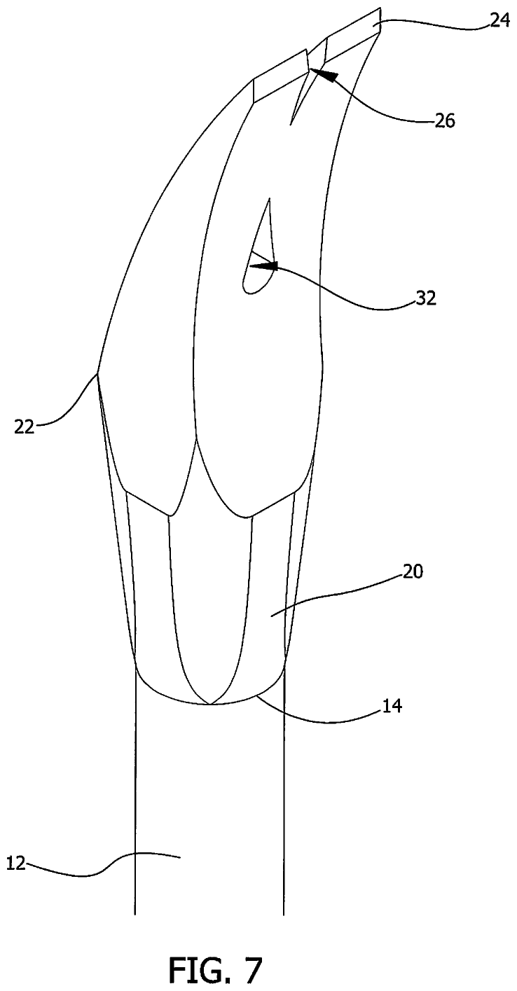

With reference now to the drawings, and in particular to FIGS. 1 through 9 thereof, a new demolition tool embodying the principles and concepts of an embodiment of the disclosure and generally designated by the reference numeral 10 will be described.

As best illustrated in FIGS. 1 through 9, the multi-tool device 10 generally comprises a shaft 12 having a first end 14 distal to a second end 16. The shaft 12 may have a length between 30.0 inches and 40.0 inches. The shaft may comprise a textured material, such as rubber or silicone, wherein the shaft is configured to facilitate gripping by a user 60. For example, the textured material may be configured to increase friction between the shaft and a hand of the user 60, for example by include textured or raised elements positioned along the shaft 12.

A first tool head 18 is coupled to the first end 14. The first tool head 18 may include a base 20 extending outwardly from the first end 14. For example, the base 20 may have a chamfered tip shape. A claw 22 generally extends outwardly from the base 20, or from the first end 14 if the base 20 is not present. The claw 22 may be curved. The claw 22 is generally parallel to the shaft 12.

Embodiments of the claw 22 may include a beveled claw end 24 that is distal to the first end 14 of the shaft 12. The beveled claw end 24 is generally parallel to the shaft 12.

A notch 26 may extend inwardly through the beveled claw end 24. The notch 24 may be centered on the beveled claw end 24 whereby the beveled claw end 24 forms a V-shape. The notch 26 is generally configured to receive a head of a nail 28 whereby the claw 22 is configured to facilitate removal of the nail 28 from an external object 30.

A through-hole 32 may extend through the claw 22. The through-hole 32 may be spaced from or aligned with the notch 26. For example, the through-hole 32 may have a teardrop shape wherein the through-hole 32 is configured to receive the head of the nail 28 whereby the claw 22 is configured to facilitate removal of the nail 28 from the external object 30. Both the notch 26 and the through-hole 32 may facilitate removal of the nail 28, or other fasteners such as staples, from the external object 30. For example, the external object 30 may comprise a floorboard or beam in a frame of a wall.

A second tool head 34 is generally coupled to the second end 16. The second tool head 34 may include an adze blade 36 extending outwardly from the second end 16. The adze blade 36 may be perpendicular to the shaft 12. The adze blade 36 may be curved. The adze blade 36 may have a thickness that is less than a thickness of the claw 22.

Embodiments of the adze blade 36 may include a beveled blade end 38. The beveled blade end 38 may be used to cut, chop, or shape the external object 30.

A slot 40 may extend inwardly through the beveled blade end 38. The slot 40 may be centered on the beveled blade end 38 whereby the beveled blade end 38 forms a V-shape, similar to the beveled claw end 24 of the claw 22. The slot 40 may be configured to receive the head of the nail 28 whereby the adze blade 36 is configured to facilitate removal of the nail 28 from the external object 30.

An aperture 42 may extend through the adze blade 36. The aperture 42 may be spaced from or aligned with the slot 40. The aperture 42 may have a teardrop shape wherein the aperture 42 is configured to receive the head of the nail 28 whereby the adze blade 36 is configured to facilitate removal of the nail 28 from the external object 30.

A pick 44 may extend outwardly from the second end 16. The pick 44 may be perpendicular to the shaft 12 and to the adze blade 36. The pick 44 may be curved. The pick 44 may have a pointed end 46 distal to the second end 16.

The second tool head 34 may further include a pair of faces 48. Each of the pair of faces 48 may have a rectangular shape. Each of the pair of faces 48 may be flat wherein each of the pair of faces 48 is configured to facilitate the user 60 in hammering the external object 30.

A plurality of ribs 50 may be positioned on the shaft 12. The plurality of ribs 50 is generally arranged between the first end 14 and the second end 16. Each of the plurality of ribs 50 may be spaced from the others wherein each of the plurality of ribs 50 is configured to indicate a respective length measurement. For example, the respective length measurement may be configured to facilitate the user 60 in spacing a plurality of studs when framing a wall. The plurality of ribs 50 may include a first rib 52 being spaced from a second rib 54, for example by 12.0 inches. The plurality of ribs 50 may also include a third rib 56 being spaced from the second rib 54, for example by 4.0 inches. In such examples, the third rib 56 is spaced from the first rib 52 by 16.0 inches. The second rib 54 is generally positioned between the first rib 52 and the third rib 56.

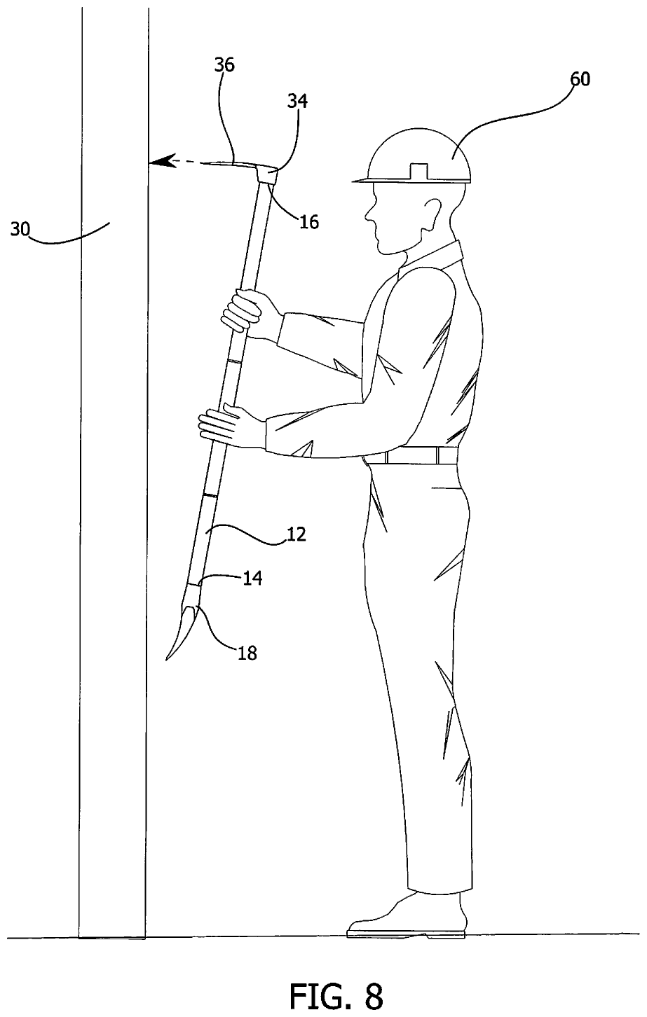

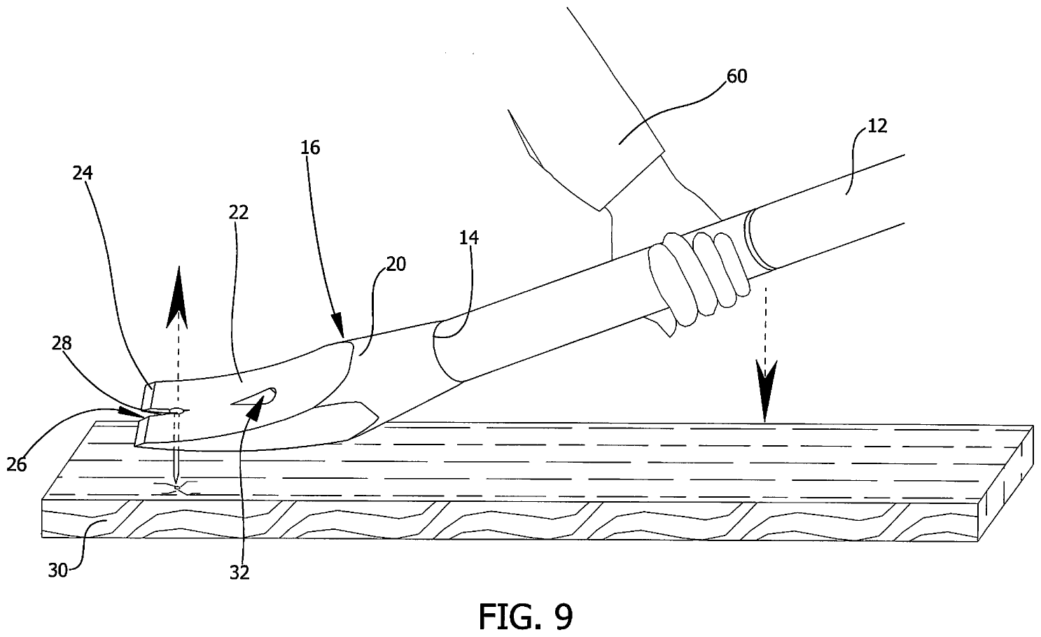

In use, the user 60 can use the multi-tool device 10 to perform a variety of construction and demolition tasks. For example, the user 60 can remove nails 28 from a board or other external object 30 using the claw 22 or the adze blade 36, as shown in FIG. 9. The user 60 can shape a piece of wood using the adze blade 36. The user 60 can also use the beveled blade end 38 to cut into the external object 30, for example by cutting a hole into a wall as shown in FIG. 8. The user 60 can also use the pair of faces 48 to hammer nails or other fasteners into the external object 30 and can perform basic measurements using the plurality of ribs 50 arranged along the length of the shaft 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tool bar assembly comprising:
a shaft having a first end distal to a second end;
a first tool head being coupled to the first end, the first tool head including:
a claw extending outwardly from the first end, the claw being curved, the claw being parallel to the shaft;
a second tool head being coupled to the second end, the second tool head including:
an adze blade extending outwardly from the second end, the adze blade being perpendicular to the shaft, the adze blade being curved,
a pick extending outwardly from the second end, the pick being perpendicular to the shaft and to the adze blade; and
a pair of faces, each of the pair of faces having a rectangular shape, each of the pair of faces being flat wherein each of the pair of faces is configured to facilitate a user in hammering an external object.

2. The tool bar assembly of claim 1, wherein the shaft has a length between 30.0 inches and 40.0 inches.

3. The tool bar assembly of claim 1, the shaft further comprising a textured material wherein the shaft is configured to facilitate gripping by the user.

4. The tool bar assembly of claim 1, the first tool head further comprising a base extending outwardly from the first end, the base coupling the claw to the first end of the shaft.

5. The tool bar assembly of claim 4, wherein the base has a chamfered tip shape.

6. The tool bar assembly of claim 1, the claw further comprising a beveled claw end being distal to the first end of the shaft.

7. The tool bar assembly of claim 6, the claw further comprising a notch extending inwardly through the beveled claw end, the notch being configured to receive a head of a nail whereby the claw is configured to facilitate removal of the nail from an external object.

8. The tool bar assembly of claim 7, wherein the notch is centered on the beveled claw end whereby the beveled claw end forms a V-shape.

9. The tool bar assembly of claim 1, further comprising a through-hole extending through the claw, the through-hole having a teardrop shape wherein the through-hole is configured to receive a head of a nail whereby the claw is configured to facilitate removal of the nail from an external object.

10. The tool bar assembly of claim 1, wherein the adze blade has a thickness being less than a thickness of the claw.

11. The tool bar assembly of claim 1, the adze blade further comprising a beveled blade end.

12. The tool bar assembly of claim 11, the adze blade further comprising a slot extending inwardly through the beveled blade end, the slot being configured to receive a head of a nail whereby the adze blade is configured to facilitate removal of the nail from an external object.

13. The tool bar assembly of claim 12, wherein the slot is centered on the beveled blade end whereby the beveled blade end forms a V-shape.

14. The tool bar assembly of claim 11, the adze blade further comprising an aperture extending through the adze blade, the aperture having a teardrop shape wherein the aperture is configured to receive a head of a nail whereby the adze blade is configured to facilitate removal of the nail from an external object.

15. The tool bar assembly of claim 1, wherein the pick is curved.

16. The tool bar assembly of claim 1, the pick further comprising a pointed end distal to the second end.

17. The tool bar assembly of claim 1, further comprising a plurality of ribs being positioned on the shaft, the plurality of ribs being arranged between the first end and the second end, each of the plurality of ribs being spaced from the others wherein each of the plurality of ribs is configured to indicate a respective length measurement.

18. The tool bar assembly of claim 17, the plurality of ribs further comprising a first rib being spaced from a second rib.

19. The tool bar assembly of claim 18, the plurality of ribs further comprising a third rib being spaced from the second rib, the second rib being positioned between the first rib and the third rib.

20. A tool bar assembly comprising:
a shaft having a first end distal to a second end, the shaft having a length between 30.0 inches and 40.0 inches, the shaft comprising a textured rubber material wherein the shaft is configured to facilitate gripping by a user;
a first tool head being coupled to the first end, the first tool head including:
a base extending outwardly from the first end, the base having a chamfered tip shape;
a claw extending outwardly from the base, the claw being curved, the claw being parallel to the shaft, the claw including:
a beveled claw end being distal to the first end of the shaft, the beveled claw end being parallel to the shaft;
a notch extending inwardly through the beveled claw end, the notch being centered on the beveled claw end whereby the beveled claw end forms a V-shape, the notch being configured to receive a head of a nail whereby the claw is configured to facilitate removal of the nail from an external object;
a through-hole extending through the claw, the through-hole being spaced from and aligned with the notch, the through-hole having a teardrop shape wherein the through-hole is configured to receive the head of the nail whereby the claw is configured to facilitate removal of the nail from the external object;
a second tool head being coupled to the second end, the second tool head including:
an adze blade extending outwardly from the second end, the adze blade being perpendicular to the shaft, the adze blade being curved, the adze blade having a thickness being less than a thickness of the claw, the adze blade including:
a beveled blade end;
a slot extending inwardly through the beveled blade end, the slot being centered on the beveled blade end whereby the beveled blade end forms a V-shape, the slot being configured to receive the head of the nail whereby the adze blade is configured to facilitate removal of the nail from the external object;
an aperture extending through the adze blade, the aperture being spaced from and aligned with the slot, the aperture having a teardrop shape wherein the aperture is configured to receive the head of the nail whereby the adze blade is configured to facilitate removal of the nail from the external object;
a pick extending outwardly from the second end, the pick being perpendicular to the shaft and to the adze blade, the pick being curved, the pick having a pointed end distal to the second end;
a pair of faces, each of the pair of faces having a rectangular shape, each of the pair of faces being flat wherein each of the pair of faces is configured to facilitate the user in hammering the external object;
a plurality of ribs being positioned on the shaft, the plurality of ribs being arranged between the first end and the second end, each of the plurality of ribs being spaced from the others wherein each of the plurality of ribs is configured to indicate a respective length measurement, the respective length measurement being configured to facilitate the user in spacing a plurality of studs when framing a wall, the plurality of ribs including:
a first rib being spaced from a second rib by 12.0 inches; and
a third rib being spaced from the second rib by 4.0 inches, whereby the third rib is spaced from the first rib by 16.0 inches.
